(19) United States
(12) Patent Application Publication
(10) Pub. No.: US 2016/0075218 A1
(43) Pub. Date: Mar. 17, 2016

(54) Remote Controlled Sun Visor

(71) Applicant: Robert Wesley Frownfelter, Tehachapi, CA (US)

(72) Inventor: Robert Wesley Frownfelter, Tehachapi, CA (US)

(21) Appl. No.: 14/484,089

(22) Filed: Sep. 11, 2014

(51) Int. Cl. B60J 3/02

(52) U.S. Cl. CPC B60J 3/0204

(57) ABSTRACT

A vehicle sun visor hat can be lowered and rotated horizontally around operator providing protection from any direction by using a remote control device conveniently located.
This invention is designed primarily for a person with a disability that restricts movement required to adjust a conventionally manually operated sun visor.

This invention requires little movement by the operator.

This invention is considerably safer than a convention sun visor. It provides seven times more horizontal coverage, twice the vertical coverage, no need to take your eyes off the road while ducking your head when moving the visor to side window. There are four options available to make this invention even more safe. One is a sun tracking device that automatically keeps the visor ideally positioned. Second it's a round (like the sun) sun visor that does not block a considerable of operators view like conventional visor does. Third is a round snap on day time sun visor. Forth is 14×14 snap on shade visor, replacing the need to hang a newspaper in the window.

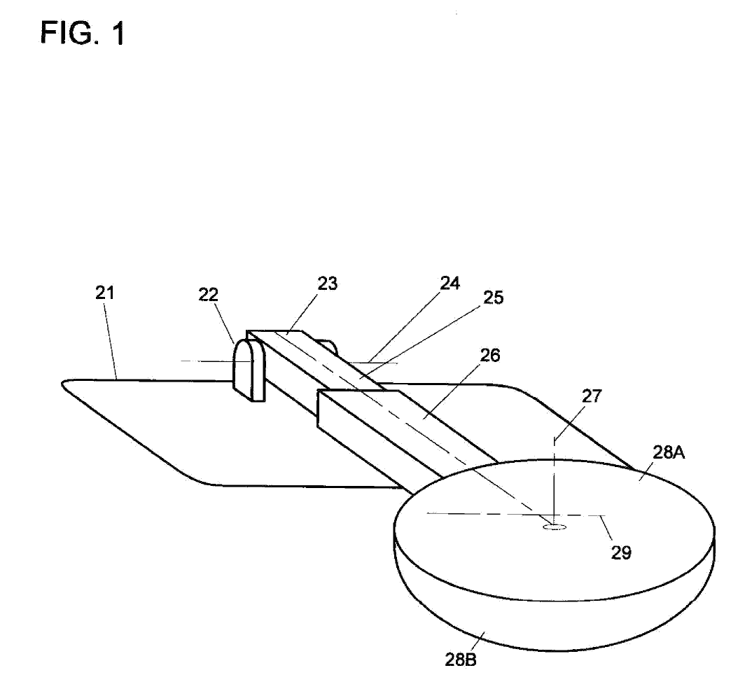

FIG. 1 is a perspective view from the rear upper left of the visor mechanism showing visor (21) visor mount arms (22) visor box (23) visor mount arms rotate center line (24) visor extension arm (25) up/down arm (26) turret center lid (27) turret lid (28A) up/down arm center line (29) turret-pan (28B)

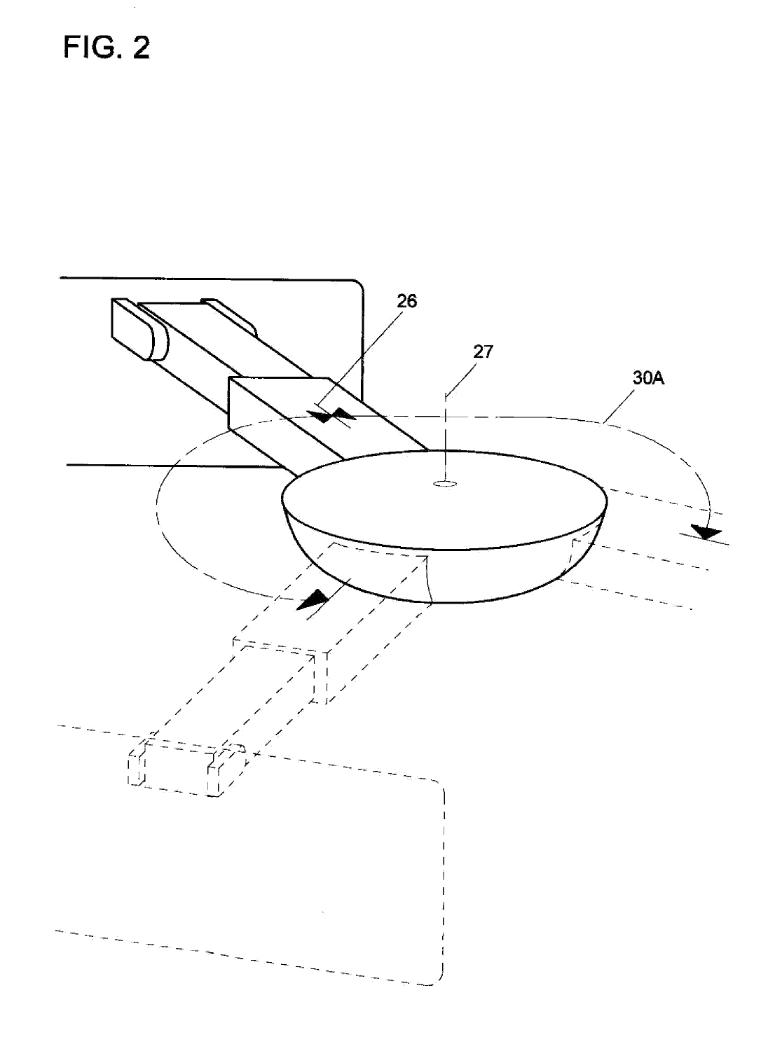

FIG. 2 shows the visor mechanism rotating (30A) on center mount (27) right or left of center (26)

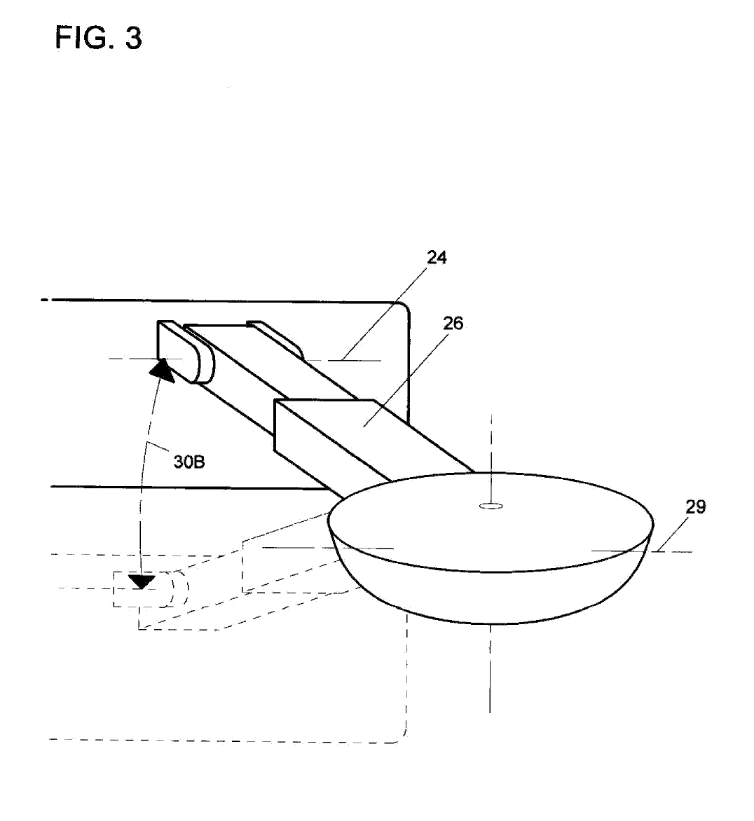

FIG. 3 shows visor up/down arm (26) and visor box center line (24) rotating (30B) down from Turret (29)

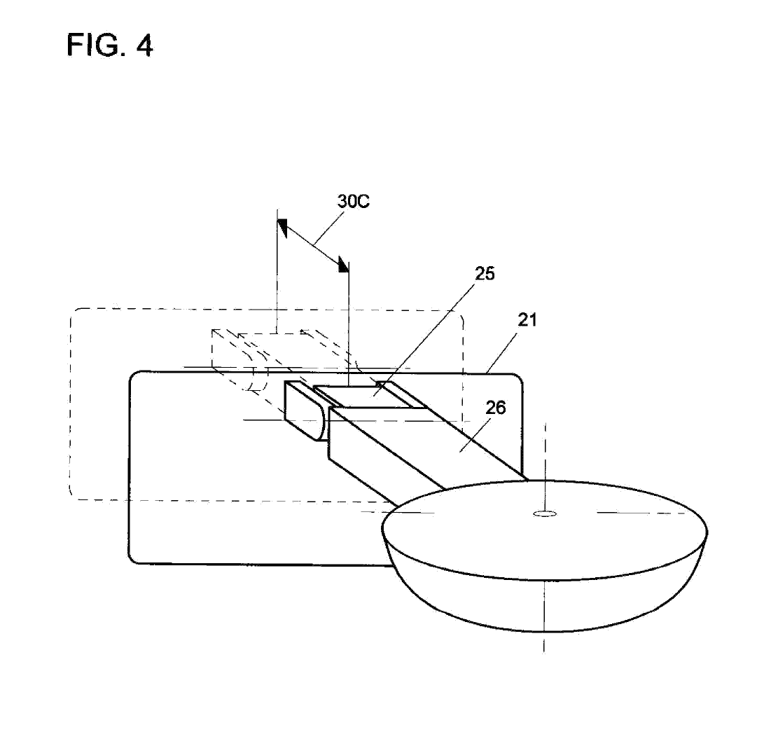

FIG. 4 shows visor (21) extended out (30C) on visor extension arm (25) that extends out of up/down 26)

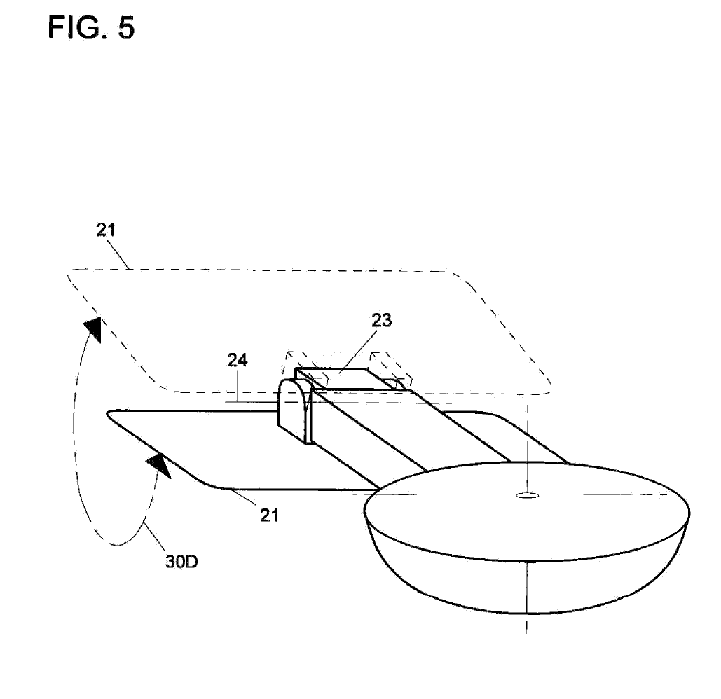

FIG. 5 shows visor (21) rotating (30D) on visor motor box (23) center line (24)

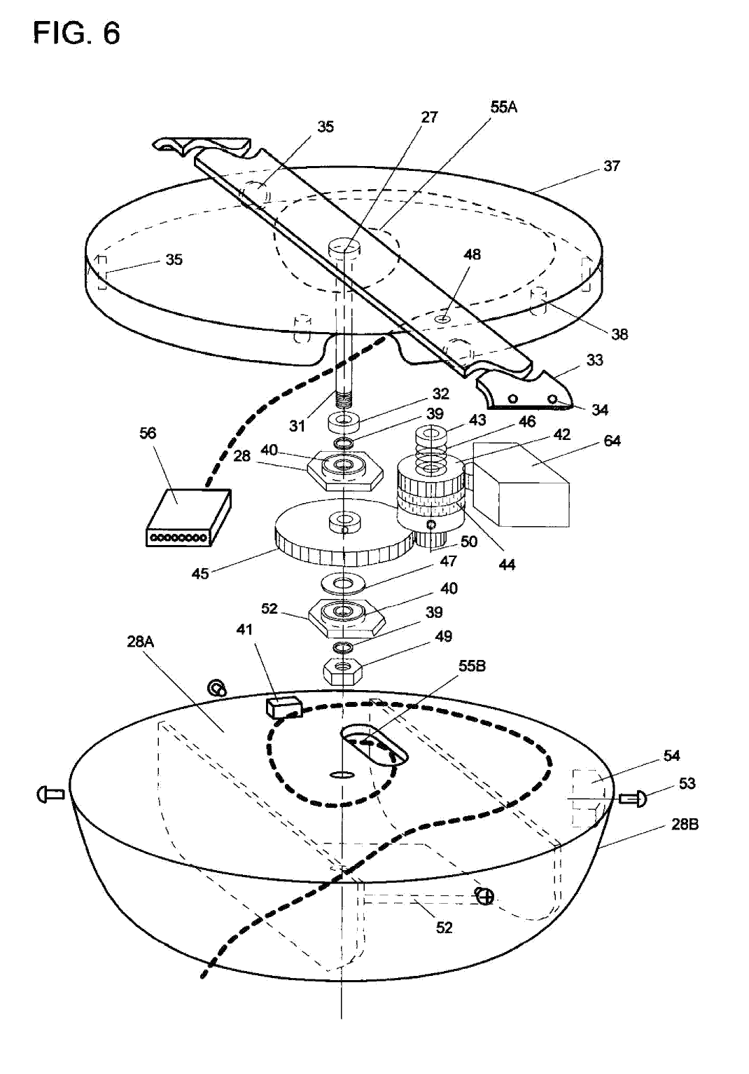

FIG. 6 shows visor turret mechanism center lid (27) turret lid (28A) turret pan (28B) mechanism main support bolt (31) that secures mechanism to custom mount (33) attachment screw holes (34) spacer (32) electrical pan rollers (35) electric pan (37) turret lid stops (38) spacer (39) bearing (43) limit slip clutch contacts (44) turret rotate main gear (45) spring (46) washer (47) visor mount to electrical pan lock screw (48) lock nut (49) limited slip clutch center line (50 center line turret pan support screw (54) electrical cable (55) passing through turret lid (55B) eight point electrical connection (56)

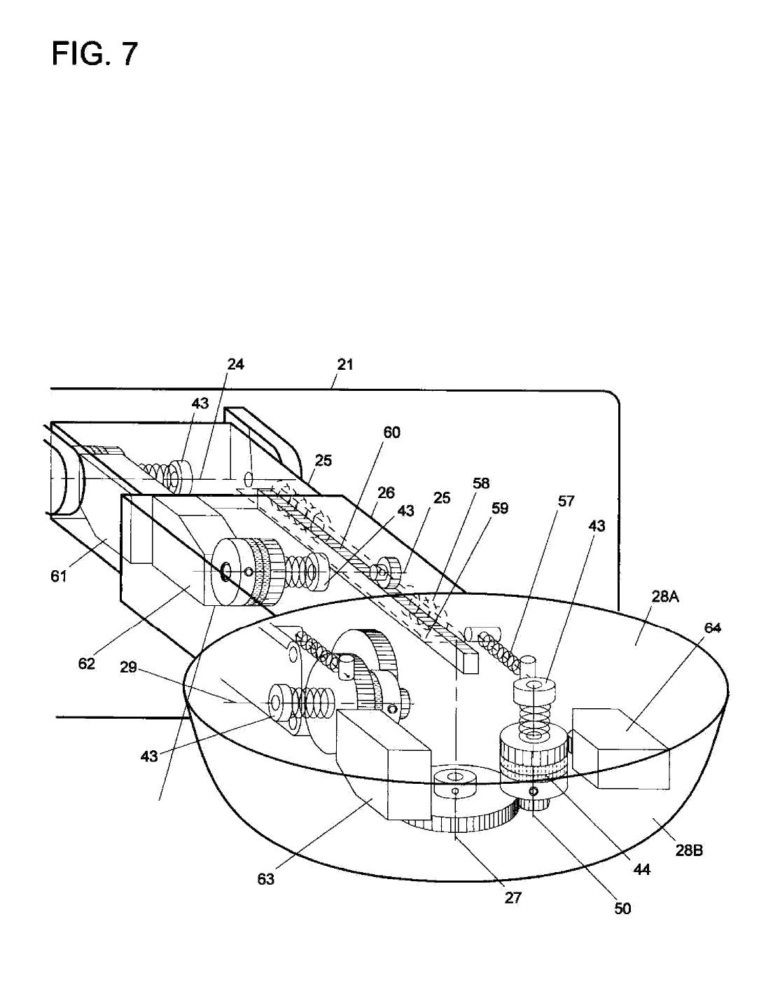

FIG. 7 sun visor (21) sun visor limited slip clutch center line (24) extension arm (25) up/down arm (26) turret main bolt center line (27) turret lid (28A) turret pan (28B) up/down arm limited slip clutch center line (29) bearing (43) limited slip clutch pads (44) turret rotation limited slip clutch cooler line (50) up/down; arm lifting assist spring (57) electrical wire coil (58) coiled electrical wire support tray (59)) extension arm gear rack (60) sun visor motor (61) extension arm motor (62) up/down arm motor (63)

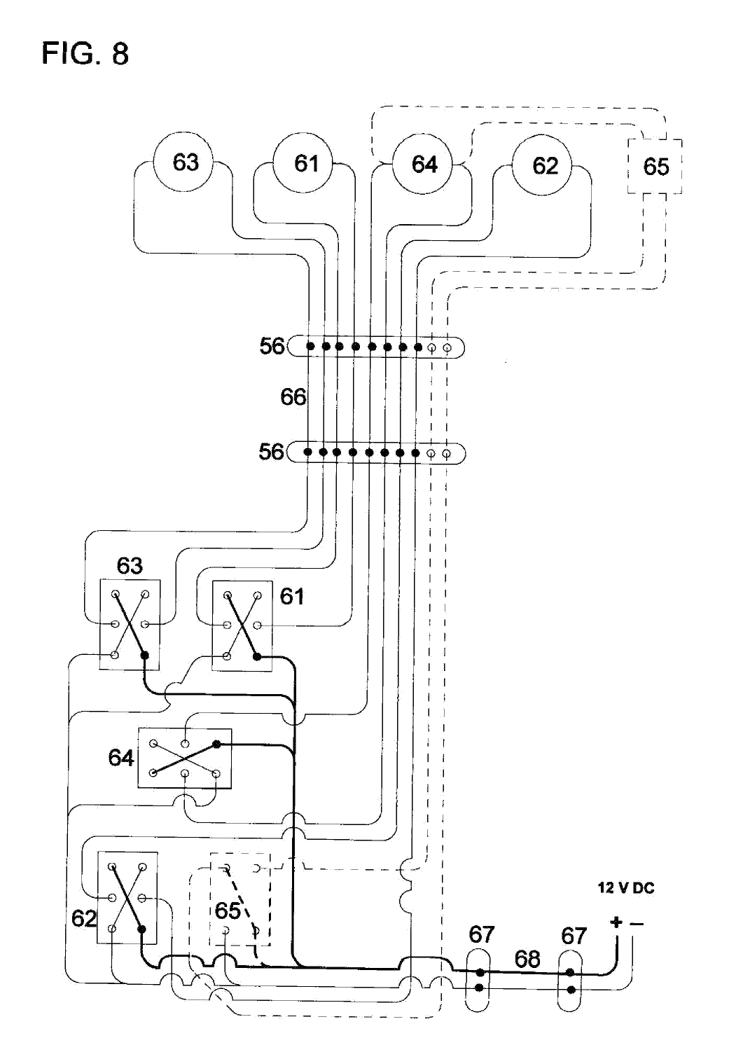

FIG. 8 Electrical layout of 12 volt direct current system through connector (6) thirty-six inch two wire cable (68) through second connector (67) to optional sun tracker switch (65) extend arm switch (62) turret rotate switch (64) up/down arm switch (63) sun visor switch (61) through eight wire connector (56) eighty-four inch eight wire cable (66) through second connector (56) to up/down arm motor (63) sun visor motor (61) rotate motor (64) extend arm motor (62)

The foregoing is an exemplary description of the present invention, and the description and accompanying drawings are illustrative of the depicted embodiments of the present invention. Various modifications to what is shown and described will be readily apparent to those of skill in the art upon reading this disclosure. Such modifications are considered to be within the spirit and scope of the present invention.

The invention claimed is :

1. A vehicle sun visor that can be lowered and rotated horizontally around operator by remote control blocking the sun essentially from any direction.

2. A vehicle sun visor system partly comprised of four visible moving parts.

3. Said first part is the sun visor and its individual mechanical and electrical parts required to control its movement remotely.

4. Said second part is the extension arm and its individual mechanical and electrical parts required to control its movement remotely.

5. Said third part is the up/down arm and its individual mechanical and electrical parts required to control its movement remotely.

6. Said forth part is the turret and its individual mechanical and electrical parts required to control its movement remotely.

7. Said parts are mechanically connected to one another comprising a single unit.

8. Movements of said parts are controlled by a remote device.

9. A vehicle sun visor component, comprising: a turret housing that is attached to vehicle and rotates horizontally.

10. A vehicle sun visor component, comprising: a up/down arm that is attached to said turret and rotates vertically off said turret.

11. A vehicle sun visor component, comprising: a extension arm that extends out of said up/down arm.

12. A vehicle sun visor component, comprising: a sun visor that rotated vertically down or back up at the end of said extension arm.

13. A vehicle sun visor device, comprising: an optional sun tracking system that controls said turrets horizontal movement automatically if switched on.

14. A vehicle sun visor device, comprising: a remote control system.

15. Said turret is attached to vehicle overhead above operator's.

16. Said turret can rotate sun visor system from center of said operator's view 160 degrees horizontally to behind said operator's left shoulder.

17. Said turret can rotate sun visor system from center of said operator's view 160 degrees horizontally to behind said operator's right shoulder.

18. Said up/down arm can lower said sun visor system from its stowed position.

19. Said up/down arm can raise said sun visor system back to its stowed position.

20. Said extension arm can extend said sun visor system.

21. Said extension arm can retract said sun visor system.

22. Said sun visor can rotate from its stowed position under said up/down arm down and around to forward of its said stowed position.

23. Said sun visor can rotate down and around back to its said stowed position.

24. Said optional sun tracking device is designed to keep sun visor in optimum position by directing said turret motor.

25. Said operator can over ride said optional sun tracking devise with switch on said remote control.

26. Said remote control consists of five automotive type switches one is an optional on/off and four are on/auto off/on, all are rocker switches.

27. Said switches are arranged in order of use.

28. Said order of use —up/down— —sun visor— —rotate— —extend— —optional sun tracker—.

29. Switch physical arrangement—passenger looking down on left side—left hand finger pressing rearward on remote control switches.

30. Top left switch mounted vertical operates up/down arm-press bottom half lowers arm, press top half raises arm.

31. Top right switch mounted vertical operates sun visor-press bottom half lowers sun visor, press top half returns sun visor to stowed position.

32. Turret rotation switch is mounted horizontally below up/down arm and sun visor switches—press left side of switch and visor rotates horizontally to operator's left, press right side of switch and sun visor rotates horizontally to operators right.

33. Bottom left switch mounted vertical operates extension arm—press bottom half extends arm, press top half retracts arm.

34. Bottom right switch mounted vertically is optional sun tracker switch—to activate press bottom half to deactivate press top half.

35. Said sun visor claim 3 mechanical and electrical consists of a housing area at end of extension arm, claim 4 housing a motor, gears, limit slip clutch, drive shaft.

36. Said drive shaft claim 35 connects to visor supporting arms on outside of said housing.

37. Said visor supporting arm claim 36 connect to claim 3 sun visor.

38. Limit slip clutch claim 35 eliminates excessive strain on motor, gears, sun visor and anything sun visor comes in contact with.

39. Extension arm claim 4 housing contains claim 3 sun visor mechanism and motor, gears, limit slip clutch, drive shaft and drive gear used to extend or retract extension arm.

40. Extension arm claim 4 drive gear meshes with rack gear mounted to claim 5 up/down arm.

41. Up/down arm claim 5 rotates vertically off turret lid up/down arm structure claim 6 and supports extension arm within.

42. Turret claim 6 consists of a pan an pan lid.

43. Turret lid claim 41 supports up/down arm claim 5 mechanical and electrical parts.

44. A support bolt attaches entire sun visor system to custom made mount.

45. Support bolt passes through turret lid and attaches to custom mount.

46. Entire sun visor mechanism is supported and rotates horizontally on this bolt.

47. Custom mount attaches to vehicle overhead.

48. Methods of mounting custom mount to vehicle are too numerous and therefore not claimed.

49. 12 volt direct current from vehicle enters sun visor system at remote control.

50. Four of five remote control switches are on/auto-off/on type and transfer current to reversible motors in sun visor system.

51. A fifth switch is a on or off rocker type for the sun tracking devise claim 13, claim 24.

52. An electrical housing pan mounted upside down and fixed to main support bolt claim 44.

53. Said pan claim 52 houses coiled 12 volt direct current electrical cable.

54. Said electrical cable coil claim 53 uncoils or recoils as turret claim 6 rotates.

55. Electrical cable claim 53 enters electrical housing pan claim 52 and forms a lose coil that can expand or retract inside this pan then exits down through turret lid claim 43.
